(19) United States
(12) Patent Application Publication
(10) Pub. No.: US 2003/0100261 A1
(43) Pub. Date: May 29, 2003

(54) Apparatus and method for delayed answering of mobile telephones

(75) Inventors: Carl Phillip Gusler, Austin, TX (US); Rick Allen Hamilton II, Charlottesville, VA (US)

Correspondence Address: Duke W. Yee, Carstens,Yee & Cahoon, LLP, P.O. Box 802334, Dallas, TX, 75380, US

(73) Assignee: International Business Machines Corporation, Armonk, NY

(21) Appl. No.: 09/998,028

(22) Filed: Nov. 29, 2001

(51) Int. Cl. H04B 1/38

(52) U.S. Cl. 455/18; 455/553

(57) ABSTRACT

An apparatus and method for delayed answering of calls directed to mobile telephones are provided. With the apparatus and method, a mobile telephone may be set to a delayed answering mode which provides a brief delay between answering of the call and actual conversation by the called party. That is, the call may be answered, but the attention of the called party is not required until the elapse of a particular delay period. This delay period allows the called party to gracefully discontinue current involvement that is requiring the attention of the called party so that the called party's attention can then be provided to the calling party. The delayed answering mode may be entered in any of a number of different ways. For example, the mobile telephone may be set to a delayed answering mode in response to a setting directed by the user of the mobile telephone, based on an identification of a calling party, based on a schedule of events, based on a physical location of the user of the mobile telephone, and the like.

### BACKGROUND OF THE INVENTION

1. Technical Field

The present invention is directed to an improved mobile telephone system. More specifically, the present invention is directed to an apparatus and method for providing delayed answering of mobile telephones.

2. Description of Related Art

As cellular, mobile and wireless telephones proliferate, they offer many ways for people and organizations to improve their communications reach and effectiveness. However, there is a fundamental conflict between how people expect to make and receive telephone calls, and how people expect interpersonal communications to flow in a social setting. Expectations for instant access can make use of mobile telephones unsafe or undesirable in certain settings.

With the current mobile telephones, the user has a dilemma about receiving calls, and limited choices for dealing with incoming calls, i.e. either answering the call or ignoring the call. Based on years of conditioning, the standard human telephone caller expects that when he/she calls someone, if the receiving person answers then the receiver must be available for immediate discussion. The caller generally expects to have the receiving person's immediate undivided attention. This is a problem for the receiving person when he or she would like to take the call, but is not ready to provide immediate attention.

For example, mobile telephones are increasingly being used while driving automobiles. This has lead to increased concern regarding distracted drivers and the danger they represent to other drivers on the road. When receiving a call, the driver's attention is at least momentarily distracted from the operation of the vehicle. If the driver decides to answer the call, the driver's attention is distracted for even greater periods of time.

As another example, many times mobile telephones ring at inappropriate times. For example, an individual may be involved in a conversation with another person when his/her mobile telephone rings. Again, the individual's attention is at least momentarily distracted from the event at hand, i.e. the conversation with the other person. At this time, the individual must make the decision to either answer the telephone or ignore it and let it ring until the automated answering service takes over answering of the call. If the individual answers the call, this may be regarded as impolite to the person with which the individual is conversing. If the individual does not answer the call, the ringing of the telephone may be distracting.

Thus, it would be beneficial to have an apparatus and method for answering a call which does not require the immediate attention of the called party but also does not require the caller to leave a message with an answering machine or service.

### SUMMARY OF THE INVENTION

The present invention provides an apparatus and method for delayed answering of calls directed to mobile telephones. With the present invention, a mobile telephone may be set to a delayed answering mode which provides a brief delay between answering of the call and actual conversation by the called party. That is, the call may be answered, but the attention of the called party is not required until the elapse of a particular delay period. This delay period allows the called party to gracefully discontinue current involvement that is requiring the attention of the called party so that the called party's attention can then be provided to the calling party.

The delayed answering mode may be entered in any of a number of different ways. For example, the mobile telephone may be set to a delayed answering mode in response to a setting directed by the user of the mobile telephone, based on an identification of a calling party, based on a schedule of events, based on a physical location of the user of the mobile telephone, and the like. Other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a mobile telephone network according to the present invention;

FIG. 2 is an exemplary diagram illustrating the primary operational components of a mobile telephone in accordance with the present invention;

FIG. 3 is an exemplary diagram illustrating the primary operational components of a base station control system in accordance with the present invention; and

FIG. 4 is a flowchart outlining an exemplary operation of the present invention.

### DETAILED DESCRIPTION OF THE PREFERRED EMBODIMENT

The present invention provides an apparatus and method for delayed answering of mobile telephones. While the principle preferred embodiment is directed to a mobile telephone, the present invention is not limited to such. Rather, the present invention is applicable to any mobile device where immediate communication using the device may not be safe or desirable. Such devices may include mobile telephones, cellular telephones, personal digital assistants (PDAs), pagers, portable computers, portable communication devices, and the like.

The preferred embodiments of the present invention will be described in terms of a cellular telephone network only for illustrative purposes. The use of a cellular telephone in the following description is not intended to place any limitations on the present invention with regard to the type of communication device or communication network in which the present invention may be implemented. Any mobile communication device and/or mobile communication network may be used without departing from the spirit and scope of the present invention.

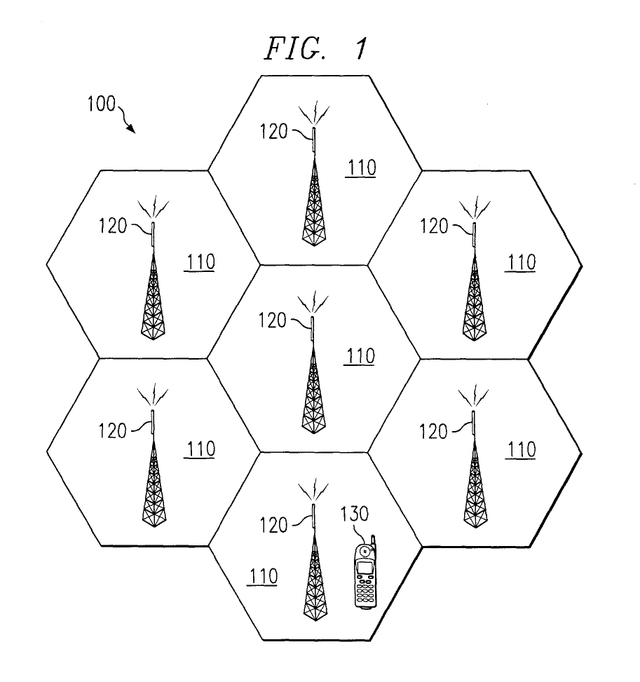

Referring now to FIG. 1, a cellular telephone network is illustrated in accordance with the present invention. As shown in FIG. 1, cellular telephone network 100 is comprised of a plurality of cells 110 and base stations 120. Each cell 110 in the cellular telephone network 100 includes a base station 120 with which cellular devices in the cell communicate.

When a cellular telephone 130 is present in the cellular network 100 and is made active, such as by powering on the cellular telephone, the cellular telephone 130 performs a handshake operation with a base station 120 corresponding to the cell in which the cellular telephone 130 is present. The handshake operation informs the base station 120 of the identity of the cellular telephone 130 and allows the base station 120 to assign a frequency on which the cellular telephone 130 is to communicate, in a manner generally known in the art. In addition, the handshake operation allows for the initialization of billing account management and other functions performed by the base station 120.

The cellular telephone 130 includes the delayed answering functionality of the present invention. This functionality may be implemented entirely within the cellular telephone 130 itself, as part of a service offered through the base station 120 or cellular network, or any combination of implementations in which a portion of the functionality is performed in the cellular telephone 130 and another portion is performed by a service offered through the base station 120 or cellular network.

The delayed answering functionality allows a called party to answer a call without having to direct the called party's attention to the call immediately. When a call attempt is being made by a calling party to a called party's cellular telephone, the called party may accept the call by pressing a button on the cellular telephone, but be given a delay period in which the called party may gracefully divert his/her attention to the incoming call. This grace period may allow a called party to move to a location where taking the call is more appropriate, end or temporarily interrupt a conversation with another person, move an automobile to a more safe operating location, or the like, so that the called party's attention may be diverted to the incoming call without causing an unsafe or inappropriate condition.

With the delayed answering functionality of the present invention, the called party presses a button on the cellular telephone 130 to thereby accept the incoming call. If the delayed answering functionality is activated, the microphone pickup is disabled for a predetermined period of time, i.e. the delay period. Alternatively, the delay period may have an upper limit designated by a predetermined period of time but may be shortened by the detection of voice input to the microphone. The delay period may be set as an option by the called party. Such settings may be performed in the cellular telephone 130 itself, or may be set during registration with the cellular network, for example.

During the delay period, the calling party may be provided with a prerecorded message, assurances that their call is going to be answered momentarily, music, and the like. In this way, the calling party is informed that the called party is aware of the call and will be speaking with them shortly. Otherwise, the calling party may not realize that the call has been accepted or may get frustrated with waiting for the called party and hang-up.

The delayed answer functionality of the present invention may be integrated with other functions available to the cellular telephone 130. For example, caller-id, a local or remotely stored phone list, vibration ring, voice mail, and the like, may all be integrated and operate in conjunction with the delayed answer functionality of the present invention.

For example, caller-id and the stored phone list may be used to identify calling parties in order to determine whether to use the delayed answer functionality of the present invention. Vibration ring and voice mail may be used with the delayed answer functionality based on the particular operating mode of the cellular telephone, as described in greater detail hereafter. The delayed answer functionality of the present invention may be integrated with any now known, or later developed, functionality of the cellular telephone 130 without departing from the spirit or scope of the present invention.

The activation of the delayed answer functionality of the present invention may be performed in many different ways. For example, when the call setup signal is received by the cellular telephone 130, the called party may be given the option to answer the call in a normal manner by pressing a first button, or series of buttons, on the cellular telephone. Similarly, the called party may be given a second option for answering the call with the delayed answering function enabled by pressing a second button, or series of buttons, on the cellular telephone.

In an alternative embodiment, the activation of the delayed answer functionality may be in response to a mode setting of the cellular telephone 130. The modes may be simply normal mode and delayed answer mode. The cellular telephone may be placed in one of these modes by way of programmable settings in the cellular telephone 130 that are accessed, for example, through an on-screen menu system. Alternatively, these modes may be set by way of a physical switch on the cellular telephone 130, or the like.

Rather than simply having the two modes of normal mode and delayed answer mode, the cellular telephone may offer a number of other types of modes that may be used under certain conditions. These modes are used to control the manner by which the cellular telephone operates both with regard to the delayed answer functionality of the present invention, as well as other features available in the cellular telephone.

For example, the modes may include a driving mode, a “do not disturb” mode, a standard mode, a theatre mode, a suppressed ring mode, and the like. During the driving mode, all incoming calls may be answered using the delayed answer functionality of the present invention in order to minimize the risk of unsafe operation of the vehicle. During the “do not disturb” mode, all incoming calls may be ignored, except for only those names and numbers identified as being “VIP” (very important person) callers, which are immediately connected using the delayed answer functionality of the present invention. During this mode of operation, the calls may be redirected to a voice mailbox associated with the called party.

During the standard mode of operation, the called party may be provided with a choice of answering methods for all incoming calls including the delayed answer functionality of the present invention. During theatre mode, the ringer on the cellular telephone may be set to a vibration mode and only calls from “VIP” callers may be identified through vibration ringing. In this mode, the call from the “VIP” caller may be answered using the delayed answer functionality of the present invention.

In another embodiment of the present invention, the mode of the cellular telephone 130 may be set in response to a geographical location of the cellular telephone 130. Such an embodiment requires that the cellular telephone 130 be equipped with a location tracking device and either the cellular telephone 130 or the cellular network being equipped with a geographical database. The use of location devices and geographical databases to control the operation of a cellular or mobile telephone is described in commonly assigned and co-pending U.S. patent application Ser. No. ______ (Attorney Docket No. AUS920010561US1), entitled “Apparatus and Method for Managing a Mobile Phone Answering Mode and Outgoing Message Based on a Location of the Mobile Phone,” filed on ______, and hereby incorporated by reference.

In yet another embodiment of the present invention, the delayed answer functionality of the present invention may be integrated with scheduling software in the cellular telephone or cellular network. Recently, mobile telephones have been marketed in which personal digital assistant (PDA) software is available. Essentially, these new mobile telephones are a combination of a mobile telephone and a personal digital assistant. As is well known, these PDAs include scheduling software through which a user may enter events for reminder to the user.

With the present invention, the scheduler software may be modified, or alternatively additional functionality may be provided, to allow the events entered into the user's schedule to be analyzed and the mode of the cellular telephone 130 automatically set based on the type of event that is currently taking place. For example, the user may enter a meeting event into the scheduler and, based on this type of event, the cellular telephone may automatically change its operating mode to a conference mode such as that described above.

In order to discern the types of events entered into the schedule, the present invention may provide a mechanism by which the user may designate the type of event or the operational mode that is to be associated with the event. In an alternative embodiment, the cellular telephone may include a mechanism for performing term identification such that the type of event is discerned by the terms used to describe the event in the schedule. For example, if the word “meeting” or “conference” are used in the schedule, the mechanism will identify that event as a conference and set the operating mode of the telephone accordingly during that time period.

Thus, the present invention provides a mechanism by which a delayed answering functionality is added to mobile telephones. In addition, the present invention allows this delayed answering functionality to be integrated into other functions of the cellular telephone. Moreover, the present invention provides for the setting of operational modes as a way of activating the delayed answering functionality of the present invention. Furthermore, the present invention provides various mechanisms for determining the operational mode of the cellular telephone and thus, when to activate the delayed answering functionality of the present invention.

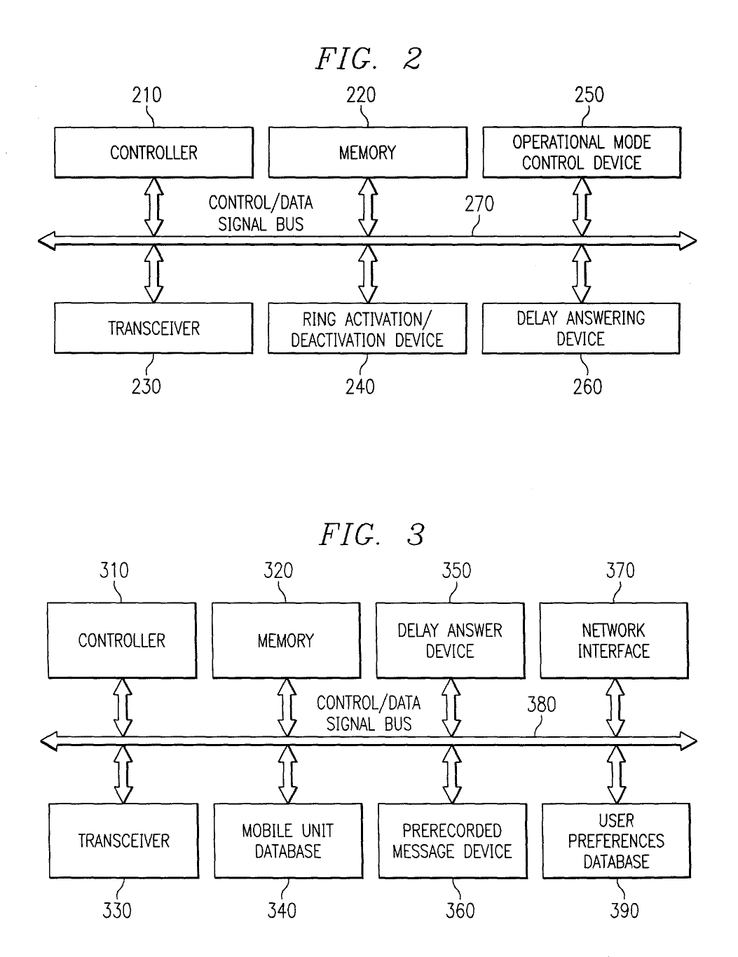

FIG. 2 is an exemplary block diagram of a mobile or cellular telephone in accordance with one embodiment of the present invention. The elements shown in FIG. 2 may be implemented in hardware, software, or a combination of hardware and software. For example, many elements may be implemented as software executed by a processor.

As shown in FIG. 2, the cellular telephone 200 includes a controller 210, a memory 220, a transceiver 230, a ring activation/deactivation device 240, an operational mode control device 250, and a delayed answer device 260. These elements 210-260 are coupled to one another by control/data signal bus 270. Although a bus architecture is shown in FIG. 2, the present invention is not limited to such and any architecture that facilitates the communication of control/data signals between the elements 210-260 may be used without departing from the spirit and scope of the present invention. The keypad, microphone, speaker and other standard parts of the cellular telephone are not shown in this diagram for simplicity.

The controller 210 controls the overall operation of the cellular telephone 200 and orchestrates the operation of the other elements 220-260. The memory 220 stores control programs and other information necessary for the operation of the cellular telephone 200. For example, the memory 220 may store settings of the cellular telephone 200, telephone number lists, caller-id information, and the like. The controller 210 operates under the control programs stored in the memory 220.

The transceiver 230 is used for sending and receiving cellular telephone calls as well as control data for performing handshake operations with base stations, and the like. In addition, the transceiver 230 may be used, is some embodiments where the delay answer functionality of the present invention is performed wholly or partly by the cellular network, to transmit current operational mode settings to the base station.

The ring activation/deactivation device 240 activates the ringer on the cellular telephone such that the telephone provides an audible ring output, such as a musical chime, indicating the receipt of a telephone call. Alternatively, the ring activation/deactivation device 240 deactivates the audible ring when instructed to by way of input from the user, in response to an operational mode of the cellular telephone 200, or when instructed by messages received from a base station.

In addition, the ring activation/deactivation device 240 may activate vibration notification for notifying the user of an incoming call by vibrating the cellular telephone. Such vibration notification may include a first vibration notification for incoming calls when the user has selected to deactivate the audible ringer. Moreover, there may be a different vibration notification provided for emergency telephone calls. The deactivation of the audible ring notification and the activation of the vibration notification may be performed based on header information of signals received from the base station, for example.

The operational mode control device 250 performs the necessary functions for setting and determining the operational mode of the cellular telephone 200. These functions may include determining the current user designated setting of the cellular telephone 200 based on the settings established by the user through an on-screen menu system, the physical position of a switch, the pressing of a button by the user, or the like. These functions may further include determining an operational mode of the cellular telephone 200 based on analysis of events in a schedule stored in memory 220, a geographical location of the cellular telephone 200 as determined by a geographical location tracking device (not shown), or the like.

The operational mode control device 250 identifies the current operational mode of the cellular telephone 200 and reports this operational mode to the controller 210. The determination of the operational mode may be performed on a periodic basis or in response to an event. For example, the operational mode control device 250 may determine the operational mode once every minute that the cellular telephone 200 is powered on. Alternatively, the operational mode control device 250 may determine the operational mode in response to receipt of a call setup message from a base station, or the like.

The controller 210 instructs the ring activation/deactivation device 240 and the delay answering device 260 how to operate based on the operational mode reported by the operational mode control device 250. If the operational mode indicates that the ringer of the cellular telephone should be disabled, the ring activation/deactivation device 240 deactivates the ringer. Further, if the operational mode indicates that the ringer should ring in vibration mode, the ring activation/deactivation device 240 may switch the ringer mode to vibration notification.

If the operational mode indicates that the delay answering device 260 should operate and the user has pressed a button on the cellular telephone 200 indicating that the user wishes to answer the call, the controller 210 sends a message to the delay answering device 260 to perform the delay answering functionality of the present invention. The delay answering device 260 transmits one or more prerecorded messages to the calling party via the transceiver 230 to reassure the calling party that the called party will be speaking with them shortly. Meanwhile, the delay answering device 260 disables the microphone or otherwise causes the cellular telephone 200 not to transmit any voice input from the microphone to the calling party.

The operation of the delay answering device 260 may continue for a predetermined time or may be cut short by voice input from the called party. In an embodiment in which voice input from the called party may cut short the delay period, a functionality may be provided in the delay answering device 260 for comparing audio input signal levels with predetermined thresholds for determining whether voice input from the called party is present.

In addition, the controller 210, in determining whether the delay answering device 260 is to operate, may access telephone lists stored in the memory 220. These telephone lists include the identification of potential calling parties, their telephone numbers, whether they are “VIP” calling parties, and the like. Based on this information and information received via the call setup messages received from the cellular network, the cellular telephone 200 may perform caller-id functions as well as determine whether this particular calling party is a “VIP” calling party. Depending on the particular embodiment and operational mode of the cellular telephone 200, if the calling party is a “VIP” calling party, the incoming call may be notified to the called party when other calls from non-VIP calling parties are not notified to the called party.

With the present invention, when a call setup message is received by the cellular telephone from a base station of the cellular network, the controller 210 receives the call setup message via the transceiver 230 and instructs the operational mode control device 250 to determine a current operational mode of the cellular telephone 250. The operational mode control device 250 then determines the current operational mode and reports it to the controller 210.

Based on the operational mode of the cellular telephone 250, the controller 210 instructs the ring activation/deactivation device 240 and the delay answering device 260 to operate. The controller 210 may also retrieve telephone number lists from the memory 220 to determine if the delay answering device 260 should operate.

In response to instruction from the controller 210, the ring activation/deactivation device 240 may change the ring setting of the cellular telephone 200. In response to instruction from the controller 210, the delay answering device 260 may operate to provide a delay period by which the called party may answer the telephone while providing prerecorded messages to the calling party.

FIG. 3 is an exemplary block diagram illustrating the primary operational components of a base station control system in accordance with the present invention. The elements shown in FIG. 3 may be implemented in hardware, software, or a combination of hardware and software. For example, many elements may be implemented as software executed by a processor.

As shown in FIG. 3, the base station control system 300 includes a controller 310, a memory 320, a transceiver 330, a cellular telephone unit database 340, a delay answer device 350, a prerecorded message device 360, a network interface 370, and a user preferences database 390. The elements 310-390 are coupled to one another via the control/data signal bus 380. Although a bus architecture is shown in FIG. 3, the present invention is not limited to such and any architecture that facilitates the communication of control/data signals between the elements 310-390 may be used without departing from the spirit and scope of the present invention.

The controller 310 controls the overall operation of the base station controller 300 and orchestrates the operation of the other elements 320-390. The controller 310 operates based on control programs stored in the memory 320. The memory 320 may also store other information used by the base station control system.

The transceiver 330 is used to send and receive calls, control signals, and data to and from cellular telephones located within the cell served by the base station. The mobile unit database 340 stores information regarding the cellular telephones located within the cells serviced by the base station, their identification, such as a MIN, and user preference information retrieved for the users of the cellular telephones in the cell serviced by the base station. The mobile unit database 340 may, in some embodiments, also store the current location information reported by location tracking devices associated with the various cellular telephones located in the cells serviced by the base station.

The delay answering device 350 operates in much the same manner as described previously. In embodiments where the delay answering functionality is provided entirely within the cellular telephone, this device may be omitted from the configuration of the base station control system 300. However, in embodiments where the delay answer functionality is performed wholly or partly by the cellular network, the base station control system 300 may include this delay answering device 350 to perform all or some of the functions previously described.

The prerecorded message device 360 stores one or more prerecorded messages in one or more languages that may be provided as outgoing messages to calling parties during the delay period between when the calling party indicates that he/she wishes to answer an incoming call and the point at which the called party actually begins conversing with the calling party. The prerecorded message device 360 may provide these messages to the calling party via the transceiver 330 based on the preferences of the user of the cellular telephone as obtained from the user preferences database 390. These prerecorded messages may be recorded by the called party or may be standardized messages offered by the operator of the cellular network.

The network interface 370 provides a communication interface between the base station control system 300 and the cellular and/or land line telephone network. Calls to cellular telephones within the cell serviced by the base station may be routed to the base station control system 300 via the network interface 370.

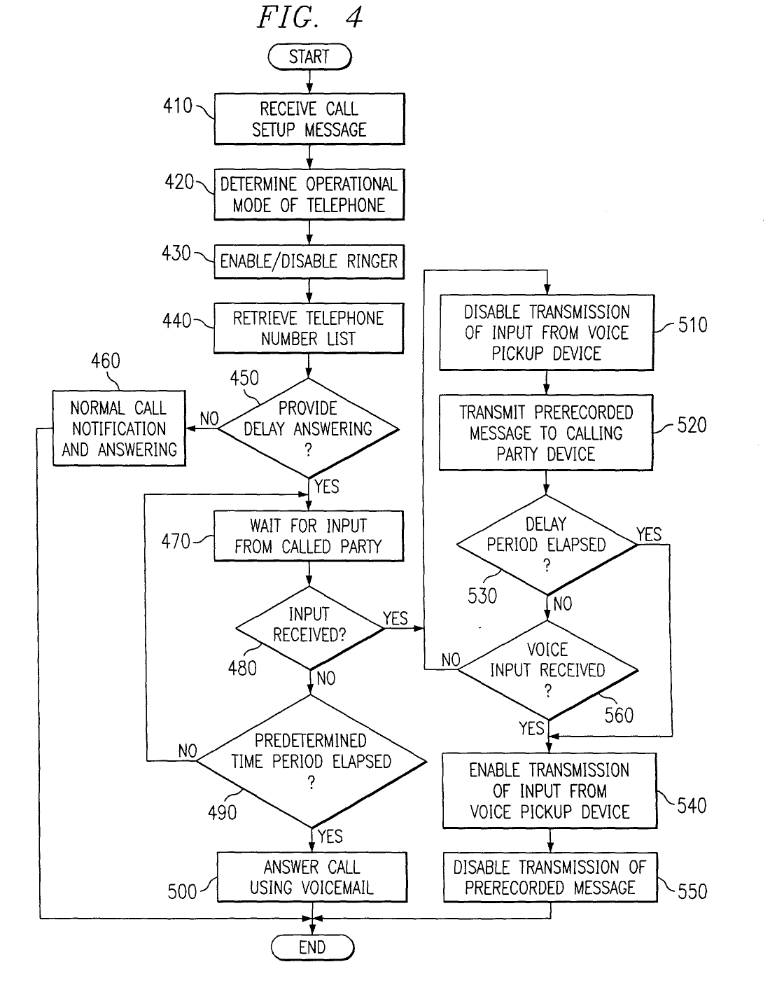

FIG. 4 is a flowchart of an exemplary operation of the present invention. The operation shown in FIG. 4 is directed to an embodiment in which the delay answering functionality is provided wholly in the mobile or cellular telephone. It should be noted that many of the steps in FIG. 4 may be performed by the base station rather than the mobile or cellular telephone and may be performed in a different order than that shown in FIG. 4.

As shown in FIG. 4, the operation starts with receipt of a call setup message from a base station (step 410). In response to receiving the call setup message, the current operational mode of the cellular telephone is determined (step 420). Based on the operational mode of the cellular telephone, a ringer of the cellular telephone is either enabled or disabled (step 430). In addition, based on the operational mode of the cellular telephone, a telephone number list may be retrieved for comparison with the telephone number associated with the call setup message (step 440).

A determination is then made as to whether delay answering should be provided (step 450). The determination of whether to provide delay answering may be based on a user-configured combination of one or more of the operational mode, caller-id information, and the like. As previously described, the operational mode may be set by the user, may be set based on the geographical location of the cellular telephone, may be set based on a current event in a stored schedule, and the like.

If delay answering is not to be provided, normal call notification and answering are provided via the cellular telephone (step 460). This normal call notification is based on the enablement/disabling of the ringer as noted above.

If delay answering is to be provided, the cellular telephone waits for an input from the called party indicating a desire to answer the incoming call (step 470). A determination is made as to whether an input is necessary or received (step 480). In certain modes, the user may select delayed auto-answer for selected callers or all callers, and the telephone may start the delayed answer process without waiting for the called party to approve the call. If input is not received, a determination is made as to whether a predetermined time period, such as a number of rings of the telephone, has expired (step 490). If not, the operation returns to step 470 and continues to wait for called party input. If so, the call is handled by voicemail functions of the cellular telephone (step 500) and the operation ends.

If a called party input is received, the cellular telephone disables transmission of input from the microphone to the calling party (step 510) and transmits a prerecorded message to the calling party (step 520). A determination is then made as to whether a delay period has elapsed (step 530). If so, the transmission of the input from the microphone is enabled (step 540) and the transmission of the prerecorded message is disabled (step 550).

If the delay period has not elapsed, a determination is made as to whether a voice input or other called party input (such as pressing a “Talk” button) is received (step 560). If not, the operation returns to step 510. If so, the operation goes to step 540.

Thus, the present invention provides a mechanism by which delayed answering of a mobile or cellular telephone may be provided. The present invention allows the called party to have a “grace” period for transferring his/her attention away from their current situation to the incoming call. By providing this grace period, or delay period, the likelihood of getting involved in a dangerous or inappropriate situation due to having to immediately change a focus of the called party's attention is avoided.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of delayed answering of calls directed to a mobile telephone, comprising:
accepting an incoming call from a calling party device;
disabling transmission of input from a voice pickup device associated with the mobile telephone during a preset delay period from a time the incoming call is accepted; and
transmitting a prerecorded message to the calling party device during the preset delay period.

2. The method of claim 1, further comprising:
in response to detection of a voice input, disabling transmission of the prerecorded message; and
enabling transmission of input from the voice pickup device.

3. The method of claim 1, wherein the preset delay period is set as an option in the mobile telephone.

4. The method of claim 1, wherein the preset delay period is set as an option when a user of the mobile telephone registers with a mobile telephone network.

5. The method of claim 1, further comprising:
determining an operating mode of the mobile telephone, wherein disabling transmission of input from a voice pickup device and transmitting a prerecorded message are performed only if the operating mode of the mobile telephone is set to an operating mode in which delayed answering is enabled.

6. The method of claim 5, wherein determining the operating mode includes detecting a delayed answer input from a user of the mobile telephone.

7. The method of claim 5, wherein the operating mode of the mobile telephone is set by way of one or more on-screen menus of the mobile telephone.

8. The method of claim 5, wherein the operating mode of the mobile telephone is set by way of a physical switch associated with the mobile telephone.

9. The method of claim 1, further comprising:
determining an identity of the calling party device;
comparing the identity of the calling party device to a list of calling party devices; and
determining if delayed answering should be used to answer the call based on the comparison, wherein disabling transmission of input from a voice pickup device and transmitting a prerecorded message to the calling party device are performed if delayed answering should be used.

10. The method of claim 1, further comprising:
retrieving a schedule of events from a memory associated with the mobile telephone;
determining if an event in the schedule of events is scheduled for a present time; and
determining if the event is an event for which delayed answering is to be used, wherein disabling transmission of input from a voice pickup device and transmitting a prerecorded message to the calling party device are performed if the event is an event for which delayed answering is to be used.

11. The method of claim 10, wherein determining if the event is an event for which delayed answering is to be used includes at least one of retrieving an identifier indicating whether delayed answering is to be used and retrieving an identifier of an operational mode of the mobile telephone associated with the event.

12. The method of claim 10, wherein determining if the event is an event for which delayed answering is to be used includes:
performing term identification on a description of the event; and
determining if one or more terms in the description of the event are associated with an operational mode of the mobile telephone in which delayed answering is enabled.

13. An apparatus for delayed answering of calls directed to a mobile telephone, comprising:
means for accepting an incoming call from a calling party device;
means for disabling transmission of input from a voice pickup device associated with the mobile telephone during a preset delay period from a time the incoming call is accepted; and
means for transmitting a prerecorded message to the calling party device during the preset delay period.

14. The apparatus of claim 13, further comprising:
means for disabling transmission of the prerecorded message in response to detection of a voice input; and
means for enabling transmission of input from the voice pickup device.

15. The apparatus of claim 13, wherein the preset delay period is set as an option in the mobile telephone.

16. The apparatus of claim 13, wherein the preset delay period is set as an option when a user of the mobile telephone registers with a mobile telephone network.

17. The apparatus of claim 13, further comprising:
means for determining an operating mode of the mobile telephone, wherein the means for disabling transmission of input from a voice pickup device and the means for transmitting a prerecorded message operate only if the operating mode of the mobile telephone is set to an operating mode in which delayed answering is enabled.

18. The apparatus of claim 17, wherein the means for determining the operating mode includes means for detecting a delayed answer input from a user of the mobile telephone.

19. The apparatus of claim 17, wherein the operating mode of the mobile telephone is set by way of one or more on-screen menus of the mobile telephone.

20. The apparatus of claim 17, wherein the operating mode of the mobile telephone is set by way of a physical switch associated with the mobile telephone.

21. The apparatus of claim 13, further comprising:
means for determining an identity of the calling party device;
means for comparing the identity of the calling party device to a list of calling party devices; and
means for determining if delayed answering should be used to answer the call based on the comparison, wherein the means for disabling transmission of input from a voice pickup device and means for transmitting a prerecorded message to the calling party device operate if delayed answering should be used.

22. The apparatus of claim 13, further comprising:
means for retrieving a schedule of events from a memory associated with the mobile telephone;
means for determining if an event in the schedule of events is scheduled for a present time; and
means for determining if the event is an event for which delayed answering is to be used, wherein the means for disabling transmission of input from a voice pickup device and means for transmitting a prerecorded message to the calling party device operate if the event is an event for which delayed answering is to be used.

23. The apparatus of claim 22, wherein the means for determining if the event is an event for which delayed answering is to be used includes at least one of means for retrieving an identifier indicating whether delayed answering is to be used and means for retrieving an identifier of an operational mode of the mobile telephone associated with the event.

24. The apparatus of claim 22, wherein the means for determining if the event is an event for which delayed answering is to be used includes:
means for performing term identification on a description of the event; and
means for determining if one or more terms in the description of the event are associated with an operational mode of the mobile telephone in which delayed answering is enabled.

25. A computer program product in a computer readable medium for delayed answering of calls directed to a mobile telephone, comprising:
first instructions for accepting an incoming call from a calling party device;
second instructions for disabling transmission of input from a voice pickup device associated with the mobile telephone during a preset delay period from a time the incoming call is accepted; and
third instructions for transmitting a prerecorded message to the calling party device during the preset delay period.

26. The computer program product of claim 25, further comprising:
fourth instructions for disabling transmission of the prerecorded message in response to detection of a voice input; and
fifth instructions for enabling transmission of input from the voice pickup device.

27. The computer program product of claim 25, wherein the preset delay period is set as an option in the mobile telephone.

28. The computer program product of claim 25, wherein the preset delay period is set as an option when a user of the mobile telephone registers with a mobile telephone network.

29. The computer program product of claim 25, further comprising:
fourth instructions for determining an operating mode of the mobile telephone, wherein the second instructions for disabling transmission of input from a voice pickup device and the third instructions for transmitting a prerecorded message are executed only if the operating mode of the mobile telephone is set to an operating mode in which delayed answering is enabled.

30. The computer program product of claim 29, wherein the fourth instructions for determining the operating mode include instructions for detecting a delayed answer input from a user of the mobile telephone.

31. The computer program product of claim 29, wherein the operating mode of the mobile telephone is set by way of one or more on-screen menus of the mobile telephone.

32. The computer program product of claim 29, wherein the operating mode of the mobile telephone is set by way of a physical switch associated with the mobile telephone.

33. The computer program product of claim 25, further comprising:
fourth instructions for determining an identity of the calling party device;
fifth instructions for comparing the identity of the calling party device to a list of calling party devices; and
sixth instructions for determining if delayed answering should be used to answer the call based on the comparison, wherein the second instructions for disabling transmission of input from a voice pickup device and third instructions for transmitting a prerecorded message to the calling party device are executed if delayed answering should be used.

34. The computer program product of claim 25, further comprising:
fourth instructions for retrieving a schedule of events from a memory associated with the mobile telephone;
fifth instructions for determining if an event in the schedule of events is scheduled for a present time; and
sixth instructions for determining if the event is an event for which delayed answering is to be used, wherein the second instructions for disabling transmission of input from a voice pickup device and third instructions for transmitting a prerecorded message to the calling party device are executed if the event is an event for which delayed answering is to be used.

35. The computer program product of claim 34, wherein the sixth instructions for determining if the event is an event for which delayed answering is to be used include at least one of instructions for retrieving an identifier indicating whether delayed answering is to be used and instructions for retrieving an identifier of an operational mode of the mobile telephone associated with the event.

36. The computer program product of claim 34, wherein the sixth instructions for determining if the event is an event for which delayed answering is to be used include:
instructions for performing term identification on a description of the event; and
instructions for determining if one or more terms in the description of the event are associated with an operational mode of the mobile telephone in which delayed answering is enabled.
